(19) United States
(12) Patent Application Publication
(10) Pub. No.: US 2024/0272857 A1
(43) Pub. Date: Aug. 15, 2024

(54) DISPLAY CONTROL APPARATUS AND DISPLAY CONTROL METHOD

(71) Applicant: Lenovo (Singapore) Pte. Ltd., Singapore (SG)

(72) Inventors: Keiichi Yoshitomi, Kanagawa (JP); Yoshitsugu Suzuki, Kanagawa (JP)

(73) Assignee: Lenovo (Singapore) Pte. Ltd., Singapore (SG)

(21) Appl. No.: 18/413,381

(22) Filed: Jan. 16, 2024

(30) Foreign Application Priority Data
Feb. 15, 2023 (JP) 2023-021615

(51) Int. Cl. G06F 3/14

(52) U.S. Cl. CPC G06F 3/1423

(57) ABSTRACT

A display control apparatus includes: a display control unit configured to execute control related to display on each of a plurality of display devices that include at least one electronic paper display device; an operation detection unit configured to detect an operation performed on a screen displayed on any of the plurality of display devices; and a determination unit configured to determine whether the operation detected by the operation detection unit satisfies a predetermined condition. The display control unit is configured to execute display control to refresh a screen of the electronic paper display device in response to the determination unit determining that the predetermined condition is satisfied.

### CROSS-REFERENCE TO RELATED APPLICATIONS

This application claims priority to Japanese Patent Application No. 2023-021615 filed on Feb. 15, 2023, the contents of which are hereby incorporated herein by reference in their entirety.

### TECHNICAL FIELD

The present invention relates to a display control apparatus and a display control method.

### BACKGROUND

In electronic paper, a phenomenon in which a previously displayed image appears as an afterimage occurs. There is a known technique that, in response to receiving a refresh instruction via an operation unit, refreshes electronic paper to eliminate afterimages (see, for example, Japanese Unexamined Patent Application Publication No. 2021-056832).

It is preferable if a display device using electronic paper (electronic paper display device) can be refreshed without user operation, as the user can be saved from having to perform operation.

For example, it is possible to refresh the electronic paper display device periodically. In this case, however, refresh may be executed despite the user watching the screen of the electronic paper display device. Since the screen temporarily goes dark at the time of refresh, the user experience (UX) decreases.

### SUMMARY

One or more embodiments of the present invention enables an electronic paper display device to be refreshed at appropriate timing without requiring user operation.

A display control apparatus according to one or more embodiments includes: a display control unit configured to execute control related to display on each of a plurality of display devices that include at least one electronic paper display device; an operation detection unit configured to detect an operation performed on a screen displayed on any of the plurality of display devices; and a determination unit configured to determine whether the operation detected by the operation detection unit satisfies a predetermined condition, wherein the display control unit is configured to execute display control to refresh a screen of the electronic paper display device in response to the determination unit determining that the predetermined condition is satisfied.

In accordance with one or more embodiments, a display control method in a display control apparatus includes: a step in which a display control unit executes display control related to display on each of a plurality of display devices that include at least one electronic paper display device; a step in which an operation detection unit detects an operation performed on a screen displayed on any of the plurality of display devices; a step in which a determination unit determines whether a state of the operation detected by the operation detection unit satisfies a predetermined condition; and a step in which the display control unit executes the display control to refresh a screen of the electronic paper display device in response to the determination unit determining that the predetermined condition is satisfied.

One or more of the above-described aspects of the present invention can achieve the effect of enabling an electronic paper display device to be refreshed at appropriate timing without requiring user operation.

### BRIEF DESCRIPTION OF THE DRAWINGS

FIG. 1 is a diagram illustrating an example of the structures of a display control apparatus and an electronic paper display device in one or more embodiments.

FIG. 2 is a flowchart illustrating an example of a procedure executed by the display control apparatus in one or more embodiments in relation to refreshing the screen of the electronic paper display device.

### DETAILED DESCRIPTION

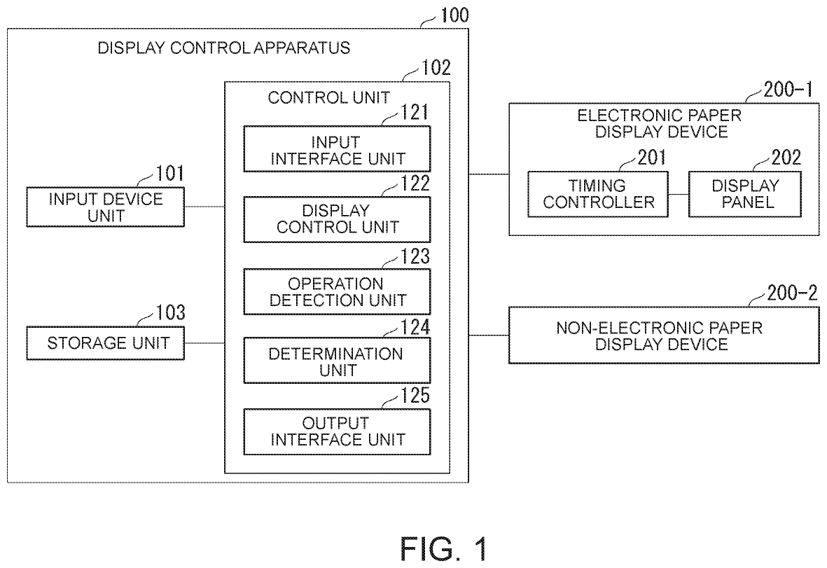

FIG. 1 illustrates an example of the structure of a display control apparatus 100 according to one or more embodiments. An example in which two display devices 200 (200-1 and 200-2) are connected to the display control apparatus 100 is illustrated in the drawing. The display control apparatus 100 according to one or more embodiments is capable of executing display control to cause each of a plurality of display devices connected to the display control apparatus 100 to display an image. Here, the display control apparatus 100 may display one user interface image using the display surfaces of the two display devices 200.

In the example illustrated in the drawing, one electronic paper display device 200-1 and one non-electronic paper display device 200-2 are connected to the display control apparatus 100 each as a display device 200. Thus, two display devices 200 are connected to the display control apparatus 100 in the example illustrated in the drawing.

The electronic paper display device 200-1 is a display device that includes a display panel as electronic paper.

An electrophoresis method is known as one of the display methods using electronic paper. As an example, electrophoretic electronic paper that supports monochrome display has a structure in which microcapsules containing white and black pigment particles electrically charged at different polarities are arranged two-dimensionally between two electrodes.

In electronic paper having such a structure, when a voltage is applied between the two electrodes to generate an electric field (potential difference) with a polarity corresponding to the display content of each pixel, either one of the white pigment particles and the black pigment particles in the microcapsule move to the display surface side and the other one of the white pigment particles and the black pigment particles move to the opposite side of the display surface, depending on the direction of the generated electric field. Monochrome display is thus performed on the display surface.

In such electronic paper, the positions of the pigment particles are substantially fixed when no electric field is generated between the electrodes. Hence, the electronic paper can maintain the display content without driving power.

The electronic paper display device 200-1 may use a display method other than the foregoing electrophoresis method. Examples of electronic paper display methods other than the electrophoresis method include a microcapsule method, an electronic powder fluid method, and a Display Electronic Slurry (DES) method.

The non-electronic paper display device 200-2 is a display device that includes a predetermined display device other than electronic paper. The non-electronic paper display device 200-2 may be, for example, a liquid crystal display or an organic electro-luminescence (EL) display.

The number of display devices 200 connectable to the display control apparatus 100 is not limited. In one or more embodiments, at least one of the plurality of display devices 200 is an electronic paper display device. All display devices 200 connected to the display control apparatus 100 may be electronic paper display devices.

The following will describe an example in which one electronic paper display device 200-1 and one non-electronic paper display device 200-2 are connected to the display control apparatus 100 each as a display device 200, as illustrated in FIG. 1.

The display control apparatus 100 may be, for example, an information processing apparatus such as a personal computer.

An example of the functional structure of the display control apparatus 100 will be described with reference to FIG. 1. The functions of the display control apparatus 100 illustrated in the drawing are implemented by a central processing unit (CPU) or a graphics processing unit (GPU) included in the display control apparatus 100 as hardware executing a program.

The display control apparatus 100 illustrated in the drawing includes an input device unit 101, a control unit 102, and a storage unit 103.

The input device unit 101 is a part that includes an input device connected to the display control apparatus 100 or an input device included in the display control apparatus 100.

The input device unit 101 may include, for example, at least one of a touch pad, a mouse, a keyboard, and a pen tablet as an input device.

In the case where the display surface of the display device 200 is a touch panel, the touch panel may be included in the input devices in the input device unit 101.

The control unit 102 executes various controls in the display control apparatus 100. The control unit 102 includes an input interface unit 121, a display control unit 122, an operation detection unit 123, a determination unit 124, and an output interface unit 125 as functional units.

The input interface unit 121 receives operation information output by the input device included in the input device unit 101 in response to the user operating the input device.

The display control unit 122 executes control related to display on each display device 200 connected to the display control apparatus 100. The display control unit 122 executes the display control on each display device 200 via the output interface unit 125.

The operation detection unit 123 detects the state of operation performed by the user using the input device on the image displayed on any display device 200.

The determination unit 124 determines whether the operation detected by the operation detection unit 123 satisfies a predetermined condition. A specific example of the condition used for the determination by the determination unit 124 will be described later.

The output interface unit 125 is a part that connects the display control apparatus 100 and each display device 200 and relays data transmission between the display control apparatus 100 and the display device 200.

The storage unit 103 stores various information supported by the display control apparatus 100. The hardware corresponding to the storage unit 103 may be, for example, a solid state drive (SSD) or a hard disk drive (HDD).

An example of the structure of the electronic paper display device 200-1 will be described with reference to FIG. 1. The electronic paper display device 200-1 includes a timing controller (TCON) 201 and a display panel 202.

The timing controller 201 drives the display panel 202 according to the display control by the display control unit 122.

The display panel 202 has a structure corresponding to the display method, and displays images by being driven by the timing controller 201.

In the electronic paper display device 200-1, a phenomenon in which a previously displayed image appears as an afterimage on the display panel 202 occurs, depending on the display method, the structure of the display panel 202 according to the display method, and the like. Refresh is performed in order to eliminate such afterimage. For refresh, for example, the timing controller 201 for the display panel 202 makes the entire display surface of the display panel 202 black and then drives the display panel 202 according to the image to be displayed. As a result of such driving for refresh, an image without any afterimage is displayed.

The electronic paper display device 200-1 may be refreshed, for example, in response to the user operating an operator provided on the electronic paper display device 200-1 or operating the input device unit 101 in the display control apparatus 100.

Alternatively, the electronic paper display device 200-1 may be refreshed periodically, such as per a predetermined number of frames or at predetermined time intervals.

However, for refresh in response to the user's operation, the user needs to operate the operator or the input device, which may be troublesome for the user. In the case where refresh is performed periodically, there is a possibility that refresh is performed when the user is watching the screen of the electronic paper display device 200-1. Since the screen temporarily goes dark at the time of refresh, the user will end up looking at the screen that has suddenly darkened. This decreases the user experience (UX).

In this specification, the term “screen” refers to an image displayed on the entire display surface of a display device.

In view of this, the display control apparatus 100 according to one or more embodiments performs control so that the electronic paper display device 200-1 will be refreshed at a timing when the user is assumed to be not watching the screen of the electronic paper display device 200-1.

Specifically, the determination unit 124 in the display control apparatus 100 determines whether a condition (refresh execution condition) that, as an operation on the image on the display device 200 detected by the operation detection unit 123, an operation of moving the cursor (an example of a position indicator) on the image displayed on the non-electronic paper display device 200-2 continues for a predetermined time or more is satisfied. The cursor herein may include, for example, a caret that indicates the input position with respect to the displayed character string during character input.

The refresh execution condition being satisfied means that the user is performing an operation of moving the cursor while watching the screen of the non-electronic paper display device 200-2. It can thus be assumed that the user is not watching the screen of the electronic paper display device 200-1.

If the refresh execution condition is satisfied, the display control unit 122 controls the electronic paper display device 200-1 to execute refresh. For example, the display control unit 122 may instruct the timing controller 201 in the electronic paper display device 200-1 to execute refresh. The timing controller 201 executes refresh in response to the instruction by the display control unit 122.

However, for example, the user may move an object on the screen, such as a window, from the screen of the electronic paper display device 200-1 to the screen of the non-electronic paper display device 200-2 by a drag operation. During such a drag operation, even if the cursor is being moved continuously for the predetermined time or more on the screen of the non-electronic paper display device 200-2, there is a possibility that part of the object is still displayed on the screen of the electronic paper display device 200-1.

If refresh is executed in such a state, an afterimage corresponding to part of the object that has moved from the screen of the electronic paper display device 200-1 to the screen of the non-electronic paper display device 200-2 appears on the screen of the electronic paper display device 200-1 after the refresh.

In view of this, the refresh execution condition may be that the operation of moving the cursor on the image displayed on the non-electronic paper display device 200-2 continues for the predetermined time or more and the image displayed on the electronic paper display device 200-1 is not being updated.

When an object is being moved in the image on the electronic paper display device 200-1, the image on the electronic paper display device 200-1 is being updated. Therefore, a state in which the image displayed on the electronic paper display device 200-1 is not being updated means that there is no movement of an object in the image on the electronic paper display device 200-1 in response to the user's operation.

With such refresh execution condition, even when the cursor is being moved on the screen of the non-electronic paper display device 200-2 continuously for the certain time or more, refresh is not executed if an object is being moved on the screen of the electronic paper display device 200-1. For example, when the movement of the object from the screen of the electronic paper display device 200-1 to the screen of the non-electronic paper display device 200-2 is subsequently completed and the user is moving the cursor on the screen of the non-electronic paper display device 200-2, the refresh execution condition is satisfied and refresh is executed.

As described above, the electronic paper display device 200-1 is refreshed in response to the refresh execution condition being satisfied. Refresh is thus executed when the user is not watching the screen of the electronic paper display device 200-1. Hence, in one or more embodiments, the electronic paper display device 200-1 is refreshed at a timing appropriate to the user without the user having to perform operation.

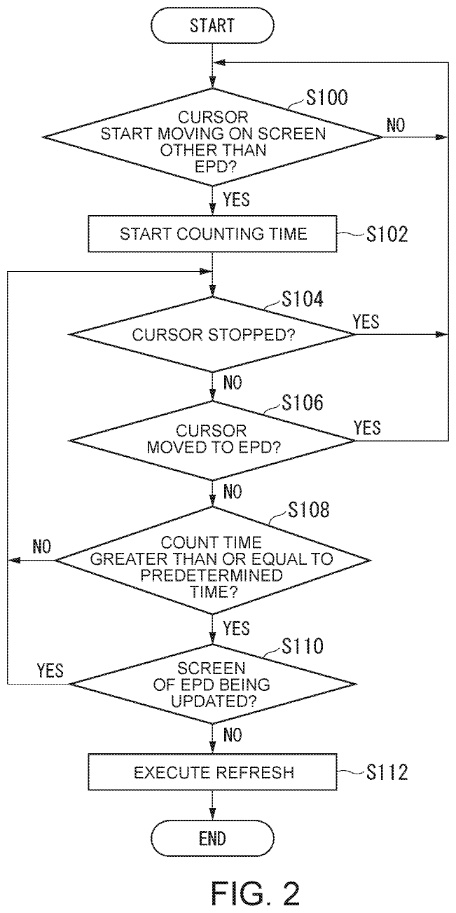

An example of a procedure executed by the display control apparatus 100 according to one or more embodiments in relation to refreshing the electronic paper display device 200-1 will be described with reference to the flowchart in FIG. 2.

Step S100: The determination unit 124 in the display control apparatus 100 waits for the cursor to start moving on the screen of a display device 200 other than the electronic paper display device (electronic paper display (EPD)) 200-1, as the state of operation on the screen of the display device 200 detected by the operation detection unit 123. Specifically, the determination unit 124 waits for the cursor to start moving on the screen of the non-electronic paper display device 200-2 out of the two display devices 200 in the structure illustrated in FIG. 1.

Step S102: When the cursor starts moving on the screen of the non-electronic paper display device 200-2, the determination unit 124 starts counting time.

Step S104: After the time counting starts in step S102, the determination unit 124 determines whether the movement of the cursor on the screen of the non-electronic paper display device 200-2 has stopped. In the case where the movement of the cursor has stopped, the procedure returns to step S100.

Step S106: In the case where the determination unit 124 determines that the movement of the cursor has not stopped in step S104, the determination unit 124 determines whether the cursor moving on the screen of the non-electronic paper display device 200-2 has moved to the screen of the electronic paper display device 200-1. In the case where the determination unit 124 determines that the cursor has moved to the screen of the electronic paper display device 200-1 in step S106, the procedure returns to step S100.

Step S108: In the case where the determination unit 124 determines that the cursor has not moved to the screen of the electronic paper display device 200-1 in step S106, the determination unit 124 determines whether the time (count time) the counting of which started in step S102 is greater than or equal to a predetermined time. In the case where the count time is less than the predetermined time, the procedure returns to step S104.

Step S110: In the case where the determination unit 124 determines that the count time is greater than or equal to the predetermined time in step S108, the determination unit 124 determines whether at least part of the screen displayed on the electronic paper display device 200-1 is being updated. In the case where the determination unit 124 determines that the screen of the electronic paper display device 200-1 is being updated, the procedure returns to step S104.

Step S112: In the case where the determination unit 124 determines that the screen of the electronic paper display device 200-1 is not being updated, the display control unit 122 controls the electronic paper display device 200-1 to refresh the screen.

According to the procedure illustrated in the drawing, each time the certain time has elapsed from when the previously stopped cursor started moving on the screen of the non-electronic paper display device 200-2, the screen of the electronic paper display device 200-1 is refreshed. There is a possibility that, while the screen of the electronic paper display device 200-1 is refreshed a plurality of times in this way, the screen of the electronic paper display device 200-1 is not updated. In such a case, the screen of the electronic paper display device 200-1 is refreshed each time the cursor is being moved on the screen of non-electronic paper display device 200-2 for the certain time or more, despite there being no need for refresh. Repeating such needless refresh may bother the user.

Accordingly, in step S100 in FIG. 2, in the case where the determination unit 124 determines that the cursor has started moving on the screen of the non-electronic paper display device 200-2, the determination unit 124 may further determine whether the screen of the electronic paper display device 200-1 has been updated after the last refresh. That is, the refresh execution condition may further include a condition that the screen of the electronic paper display device 200-1 has been updated. In this case, the procedure may return to step S100 in the case where the determination unit 124 determines that the screen of the electronic paper display device 200-1 has not been updated, and advances to step S102 in the case where the determination unit 124 determines that the screen of the electronic paper display device 200-1 has been updated. According to this procedure, even when the user performs an operation of moving the cursor on the screen of the non-electronic paper display device 200-2 for the certain time or more, refresh can be prevented if the screen of the electronic paper display device 200-1 has not been updated since the previous refresh.

For example, the electronic paper display device 200-1 is switchable between the following display modes under control of the timing controller 201: a grayscale mode (an example of a first gradation mode) in which the screen is displayed with a predetermined number of gray levels where the predetermined number is three or more; and a dither mode (an example of a second gradation mode) in which the screen is displayed with a smaller number of gray levels (for example, two gray levels) than the grayscale mode. The refresh rate in the grayscale mode is low, for example, about 2 Hz, whereas the refresh rate in the dither mode is high, for example, about 10 Hz. For refresh, a higher refresh rate is preferable from the viewpoint of UX and the like. For the image quality of the displayed screen, on the other hand, the grayscale mode is smoother and better in quality than the dither mode.

Accordingly, for example, the display control unit 122 in the display control apparatus 100 may perform control so that the electronic paper display device 200-1 will be in the grayscale mode when the refresh execution condition is not satisfied and be switched to the dither mode at the timing of performing refresh as a result of the refresh execution condition being satisfied.

The refresh structure in one or more embodiments is also applicable to display devices other than electronic paper display devices in which, due to their characteristics, afterimages appear depending on image updates.

The processes by the foregoing display control apparatus 100 may be performed by recoding a program for implementing the functions of the display control apparatus 100 on a computer-readable recording medium and causing a computer system to read and execute the program recorded on the recording medium. Herein, the expression “causing a computer system to read and execute the program recorded on the recording medium” includes installing the program in the computer system. The term “computer system” herein includes an OS and hardware such as peripherals. The “computer system” may include a plurality of computer apparatuses connected via a network such as the Internet, a WAN, a LAN, or a communication line such as a dedicated line. The “computer-readable recording medium” refers to a portable medium such as a flexible disk, a magneto-optical disc, a ROM, or a CD-ROM, or a storage device such as an HDD or an SSD embedded in the computer system. Thus, the recording medium storing the program may be a non-transitory recording medium such as a CD-ROM. The recording medium includes a recording medium internally or externally provided so as to be accessible from a distribution server for distributing the program. The code of the program stored in the recording medium of the distribution server may be different from the code of the program in a format executable on a terminal device. That is, the format in which the program is stored in the distribution server is not limited as long as it can be downloaded from the distribution server and installed in a form executable on the terminal device. A configuration in which the program is divided into a plurality of parts and the terminal device combines the parts after the parts are downloaded at different timings may be adopted, and distribution servers for distributing the parts into which the program is divided may be different. The “computer-readable recording medium” includes a medium that holds the program for a certain period of time, such as a volatile memory (RAM) inside a computer system serving as a server or a client when the program is transmitted via a network. The program may be a program for implementing part of the foregoing functions. The program may be a differential file (differential program) that can implement the foregoing functions in combination with a program already recorded in the computer system.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF SYMBOLS

100 display control apparatus
101 input device unit
102 control unit
103 storage unit
121 input interface unit
122 display control unit
123 operation detection unit
124 determination unit
125 output interface unit
200-1 electronic paper display device
200-2 non-electronic paper display device
201 timing controller
202 display panel

What is claimed is:

1. A display control apparatus comprising:
a display control unit configured to execute control related to display on each of a plurality of display devices that include at least one electronic paper display device;
an operation detection unit configured to detect an operation performed on a screen displayed on any of the plurality of display devices; and
a determination unit configured to determine whether the operation detected by the operation detection unit satisfies a predetermined condition,
wherein the display control unit is configured to execute display control to refresh a screen of the electronic paper display device in response to the determination unit determining that the predetermined condition is satisfied.

2. The display control apparatus according to claim 1, wherein the predetermined condition is that no operation is being performed on the screen displayed on the electronic paper display device out of the plurality of display devices.

3. The display control apparatus according to claim 2, wherein the predetermined condition is that a predetermined operation on a screen displayed on any of the plurality of display devices other than the electronic paper display device continues for a certain time or more.

4. The display control apparatus according to claim 3, wherein the predetermined operation is an operation involving movement of a position indicator placed on the screen.

5. The display control apparatus according to claim 2, wherein the predetermined condition further includes a condition that the screen displayed on the electronic paper display device is not being updated.

6. The display control apparatus according to claim 1, wherein the display control unit is configured to instruct the electronic paper display device to perform display in a first gradation mode with a predetermined number of gray levels in the case where the determination unit determines that the predetermined condition is not satisfied, and instruct the electronic paper display device to perform display in a second gradation mode with a smaller number of gray levels than the first gradation mode in the case where the determination unit determines that the predetermined condition is satisfied.

7. A display control method in a display control apparatus, the display control method comprising:
a step in which a display control unit executes display control related to display on each of a plurality of display devices that include at least one electronic paper display device;
a step in which an operation detection unit detects an operation performed on a screen displayed on any of the plurality of display devices;
a step in which a determination unit determines whether a state of the operation detected by the operation detection unit satisfies a predetermined condition; and
a step in which the display control unit executes the display control to refresh a screen of the electronic paper display device in response to the determination unit determining that the predetermined condition is satisfied.
